(19) United States
(12) Patent Application Publication
(10) Pub. No.: US 2014/0042929 A1
(43) Pub. Date: Feb. 13, 2014

(54) Audio Controlled Power Supplying System

(71) Applicant: REGENCY INTERNATIONAL MARKETING CORP., Taipei (TW)

(72) Inventor: Huai-Tang SHIEH, Taipei (TW)

(73) Assignee: REGENCY INTERNATIONAL MARKETING CORP., Taipei (TW)

(21) Appl. No.: 13/963,913

(22) Filed: Aug. 9, 2013

Related U.S. Application Data
(60) Provisional application No. 61/681,625, filed on Aug. 10, 2012.

(51) Int. Cl. H02J 4/00; H05B 37/02

(52) U.S. Cl. CPC H02J 4/00; H05B 37/02
USPC 315/291; 323/318

(57) ABSTRACT

An audio controlled power supplying system is disclosed, the audio controlled power supplying system comprises an audio input unit receiving an audio signal from an audio source, a processor electrically coupled to the audio input unit, the processor receives the audio signal and analyzes the audio signal to generate a control signal; and a power regulator electrically coupled to the processor, the power regulator receives the control signal from the processor and regulates an input power signal of a power source according to the control signal to generate a output power signal.

### CROSS-REFERENCE TO RELATED APPLICATION

This application claims the benefit of America Provisional Application No. 61/681,625, filed on Aug. 10, 2012, in the United States Patent and Trademark Office, the disclosure of which is incorporated herein in its entirety by reference.

### BACKGROUND OF THE INVENTION

1. Field of the Invention

The present invention relates to a power supplying system, and more particularly to an audio controlled power supplying system which can control the brightness of an illuminating unit by the inputted audio signal.

2. Description of the Prior Art

Power supplying systems may be used to regulate the power delivered to a load, to affect the operation of an electrical device such as the brightness of an illuminating unit. The power supplying system generally has an input that receives power from, for example, a standard household electrical circuit. The power supplying system may include an ON/OFF toggle switch to enable/disable any output power feeding to the load.

The output power may be varied between a minimum and a maximum depending on a power setting selected by a user of the power supplying system. The power setting may be selected in various ways including changing the position of a slider, rotating a dial or touching a touch-plate by the user.

In some occasions, decoration bulbs or the stage illumination devices are required to perform fantastic light show accompanied with the music or acoustic effect. However, the tempo or the sound quantity of music or acoustic effect is difficult to automatically and perfectly synchronize with the adjustment of the brightness of the illuminating unit used in the light show. Hence, in order to adjust the brightness of the illuminating unit synchronizing with the tempo or the sound quantity of music or acoustic effect, it would need extra. equipments or operators. As the result, an audio controlled power supplying system is required.

### SUMMARY

It is desirable to include a control mechanism according to the audio signal in the operation of a power supplying system to achieve the audio controlled power supplying system.

According one aspect of the invention, the audio controlled power supplying system comprises an audio input unit receiving an audio signal from an audio source, a processor electrically coupled to the audio input unit, the processor receives the audio signal and analyzes the audio signal to generate a control signal; and a power regulator electrically coupled to the processor, the power regulator receives the control signal from the processor and regulates an input power signal of a power source according to the control signal to generate a output power signal.

The audio controlled power supplying system may comprise a regulator switch electrically coupled between the processor and the power regulator. The regulator switch may enable or disable the control signal according to a switch status thereof. Wherein while the switch status is on, the control signal is transmitted to the power regulator, and while the switch status is off, the control signal is not transmitted to the power regulator.

The audio controlled power supplying system may comprise a surge protector electrically coupled between the power regulator and the power source. The surge protector may interrupt transmission of the input power signal when current of the input power signal is over an overloading value.

The audio controlled power supplying system may comprise a reset unit disposed in the surge protector. The reset unit may reset the surge protector to allow transmission of the input power signal.

Moreover, the power regulator may regulate frequency or voltage of the input power signal according to the control signal.

Furthermore, the power regulator is selected from the group consisting of an RC circuit, a capacitor circuit, a transistor switch circuit and a diode switch circuit.

The audio controlled power supplying system may comprise an illuminating unit electrically coupled to the power regulator. The illuminating unit may be illuminated according to the output power signal from the power regulator.

Moreover, the illuminating lay comprise light emitting diode, incandescent light bulb, fluorescent lamp, sodium vapor amp or high intensity discharge lamp.

Furthermore, the control signal is a pulse width modulation signal, and the brightness of the illuminating unit varies according to the pulse width modulation signal.

In addition, the control signal is generated according to amplitude analysis, frequency analysis or spectrum analysis of the audio signal.

The audio controlled power supplying system may further comprise an audio output unit electrically coupled to the audio input unit. The audio output unit outputting the audio signal.

The audio controlled power supplying system may further comprise an external speaker electrically coupled to the audio input unit.

As described above, the audio controlled power supplying system according to the present invention may have the following advantage that the audio controlled power supplying system can provide an output power signal to the illuminating unit according to the inputted audio signal, and thereby the extra equipment or operator would not be needed.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic block diagram of the audio controlled power supplying system according to the first embodiment of the present invention;

FIG. 2 is a schematic block diagram of the audio controlled power supplying system according to the second embodiment of the present invention;

FIG. 3 is a schematic block diagram of the audio controlled power supplying system according to the third embodiment of the present invention;

FIG. 4 is a schematic block diagram of general concept of the audio controlled power supplying system according to the present invention;

FIG. 5 is a schematic diagram of a device that equips the audio controlled power supplying system according to the present invention; and

FIG. 6 is a schematic diagram of one of the applications of the audio controlled power supplying system according to the present invention.

### DETAILED DESCRIPTION OF THE PREFERRED EMBODIMENTS

In the following detailed description, only certain exemplary embodiments of the present invention are shown and described, by way of illustration. As those skilled in the art would recognize, the invention may be embodied in many different forms and should not be construed as being limited to the embodiments set forth herein. For the convenience of understanding the description, the same elements in the embodiments will be given the same reference numerals.

In the drawing figures, the dimensions of element, unit and regions may be exaggerated for clarity of illustration. In addition, it will also be understood that when a element or unit is referred to as being “between” two elements or units, it can be the only element or unit between the two elements or units, or one or more intervening elements or units may also he present.

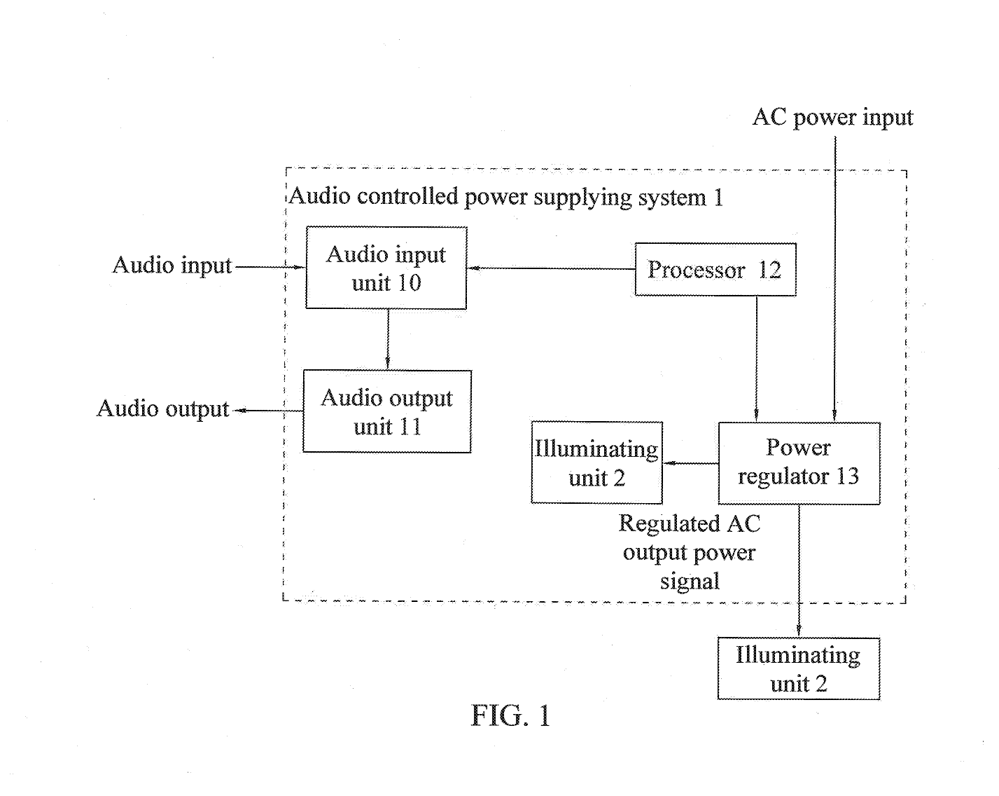

FIG. 1 illustrates a schematic block diagram of the audio controlled power supplying system according to the first embodiment of the present invention. Referring to FIG. 1, an audio controlled power supplying system 1 may have an audio input unit 10, a processor 12 and a power regulator 13. The audio input unit 10 receives an audio signal inputted from an audio source. The processor 12 is electrically coupled to the audio input unit 10, and the processor 12 receives the audio signal and analyzing the audio signal to generate a control signal. The power regulator 13 is electrically coupled to the processor 12, and the power regulator 13 receives the control signal from the processor 12 and regulates an input power signal of a power source, such as AC power or the like, according to the control signal to generate an output power signal. In addition, the power regulator is selected from the group consisting of an RC circuit, a capacitor circuit, a transistor switch circuit and a diode switch circuit. Furthermore, the processor is selected from the group consisting of central processing unit, microprocessor, application-specific instruction-set processing unit, physics processing unit, digital signal processor, coprocessor and audio processor.

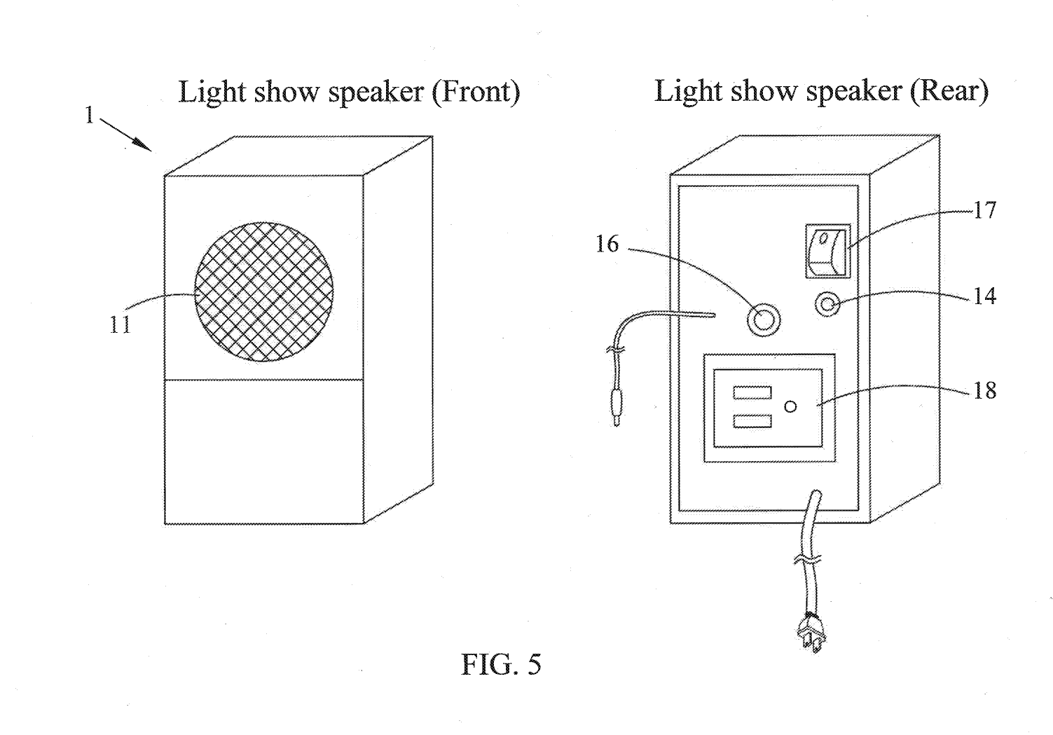

Besides, as depicted in FIG. 1, the audio controlled power supplying system 1 may further comprise an illuminating unit 2, which is electrically coupled to the power regulator 13. The illuminating unit 2 can be driven to illuminate light with variable brightness according to the output power signal from the power regulator 13. In addition, the illuminating unit 2 may be a built-in illuminating unit in the audio controlled power supplying system 1. Also, the illuminating unit 2 may be an external unit connected to the power output unit 18(as shown in FIG. 5) of the audio controlled power supplying system 1. Furthermore, the illuminating unit 2 may comprise light emitting diode, incandescent light bulb, fluorescent lamp, sodium vapor lamp, high intensity discharge lamp or the like.

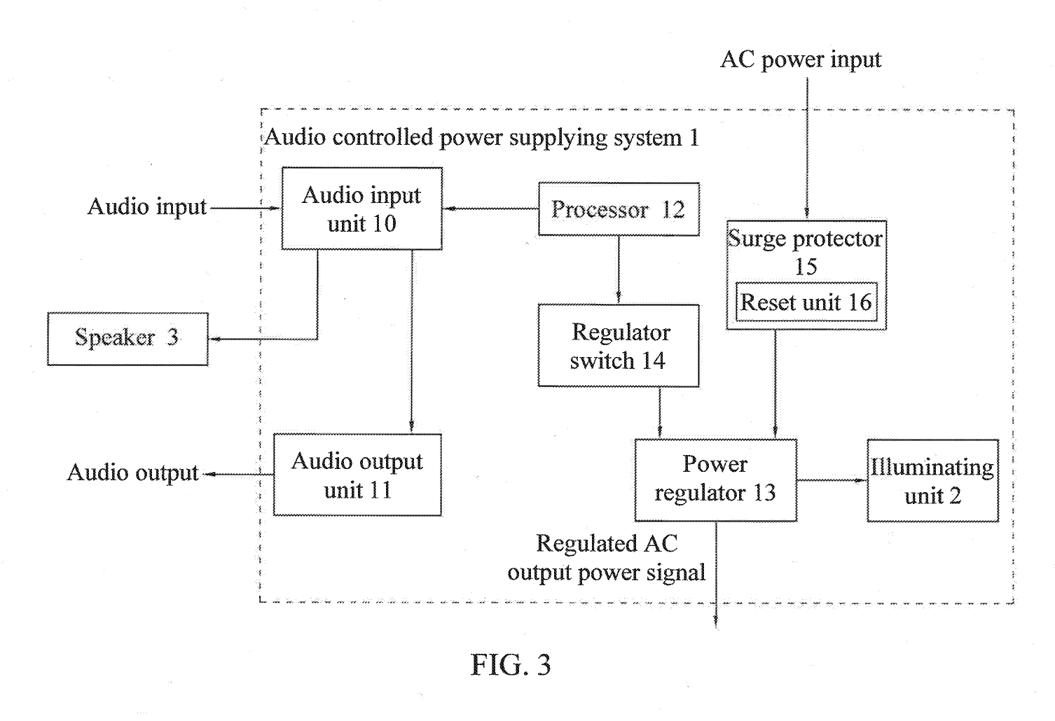

Besides, as drawn in FIG. 1, the audio controlled power supplying system 1 may further comprise an audio output unit 11, which is electrically coupled to the audio input unit 10. The audio output unit 11 may output the audio signal received from the audio input unit 10. It is worthy to note that the audio output unit 11 may be arranged as a built-in audio output device in the audio controlled power supplying system 1, or may be arranged as an external device, such as a speaker 3, which is shown in FIG. 3. Both of them may output the audio signal in a form of acoustic sound wave, analog audio signal, digital audio signal or the like.

While the audio controlled power supplying system 1 is under operation, the inputted audio signal can be analyzed by the processor via the amplitude analysis, frequency analysis or spectrum analysis. For one example, the whole audio signal is sampled at a predetermined sampling rate, and thereby the amplitude of the audio signal at each sampling point of time may be determined. Such sampled signal of amplitude analysis may be served as the control signal. For another example, signals of one or more frequency of the audio signal may be extracted after spectrum analysis. The extracted signals may then be superimposed or mixed together to serve as the control signal. After that, the power regulator 13 may regulate the input power signal according to the control unit and then output the output power signal to the illuminating unit 2, so as to drive the illuminating unit 2 illuminating light according to the output power signal to perform dim, different brightness level or flash effect. As the result, with different kinds of the music or audio signals including different tempo, different amplitude of sound or the like, the illuminating unit 2 will illuminate the light accordingly,

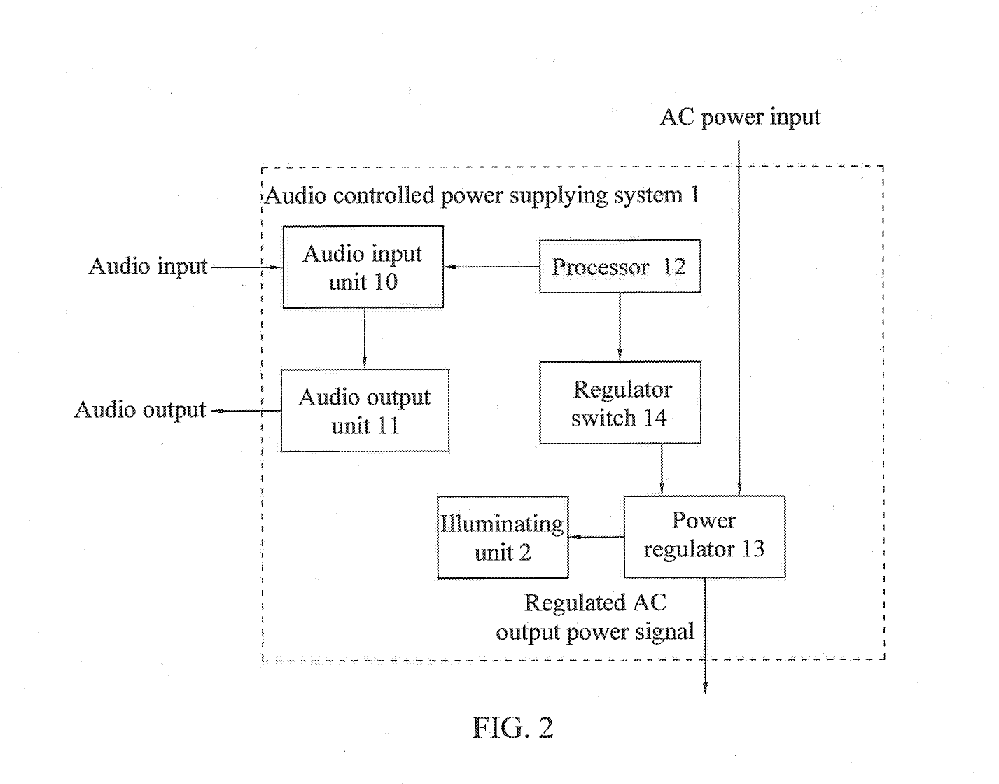

FIG. 2 illustrates a schematic block diagram of the audio controlled power supplying system according to the second embodiment of the present invention. Referring to FIG. 2, an audio controlled power supplying system 1 may further have a regulator switch 14 electrically coupled between the processor 12 and the power regulator 13. The regulator switch 14 may enable or disable the control signal according to a switch status thereof. That is to say, while the switch status is on, the control signal is transmitted to the power is regulator 13, and while the switch status is off, the control signal is not transmitted to the power regulator 13. As the result, when the control signal is transmitted to the power regulator 13 during the switch status of the regulator switch 14 being on, the power regulator 13 will output the output power signal to illuminate the illuminating unit 2 according to the control signal. When the control signal is not transmitted to the power regulator 13, the illuminating unit 2 will simply be illuminated by the power regulator 13, without manipulating the output power signal. Hence, the regulator switch 14 can provide a simplest method for the users to turn ON/OFF the light show of the illuminating unit 2 according to any kind of the music in any time or any where if they desire to do so.

FIG. 3 illustrates a schematic block diagram of the audio controlled power supplying system according to the third embodiment of the present invention. Referring to FIG. 3, an audio controlled power supplying system 1 may further have a surge protector 15 and a reset unit 16 disposed in the surge protector 15. The surge protector 15 is electrically coupled between the power regulator 13 and the power source. When current of the input power signal exceeds an overloading value, the surge protector 15 will interrupt transmission of the input power signal from the power source to protect the audio controlled power supplying system 1. The reset unit 16 may reset the surge protector 15 to allow transmission of the input power signal from the power source.

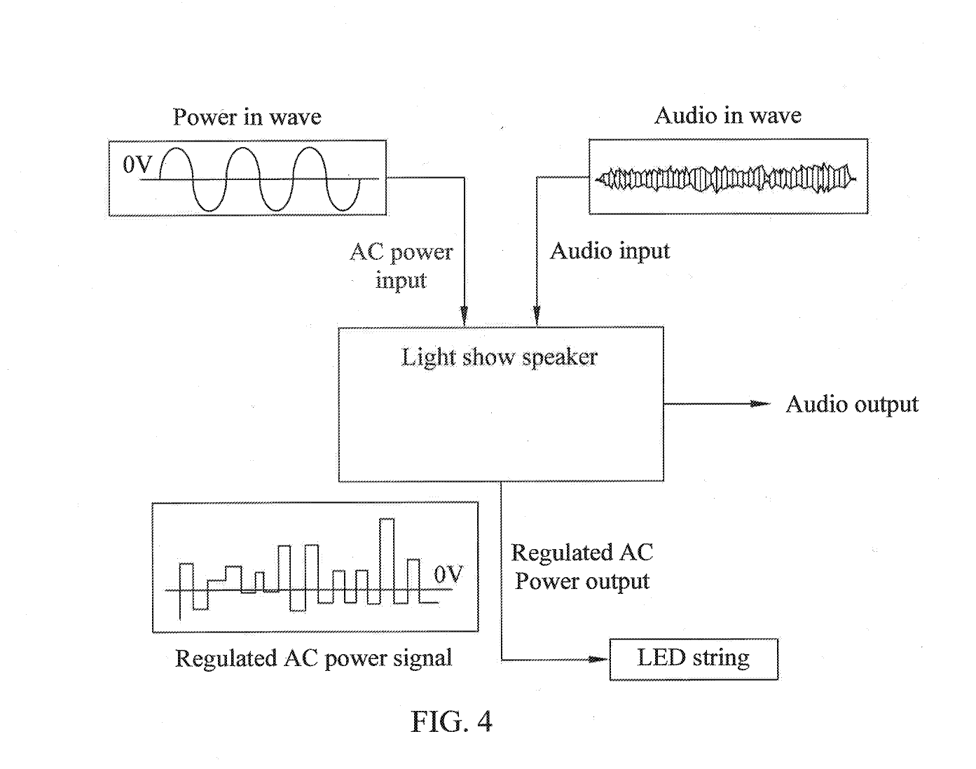

FIG. 4 illustrates a schematic block diagram of general concept of the audio controlled power supplying system according to the present invention. Referring to FIG. 4, an audio controlled power supplying system 1, such as a light show speaker, may receive the signal from the power source, such as power in sin-wave pattern, and the signal from the audio source, such as audio signal in sound-wave pattern. After finishing the aforementioned procedures of analyzing and regulating, the light show speaker may output the audio signal via the audio output unit 11, such as a speaker 3, and output the power signal, such as a regulated AC power signal, to the illuminating unit 2, such as a LED sting. That is to say, one of the applications of the audio controlled power supplying system 1; ex: light show speaker, in the present invention may perform a light dancing show according to the different types or kinds of the music.

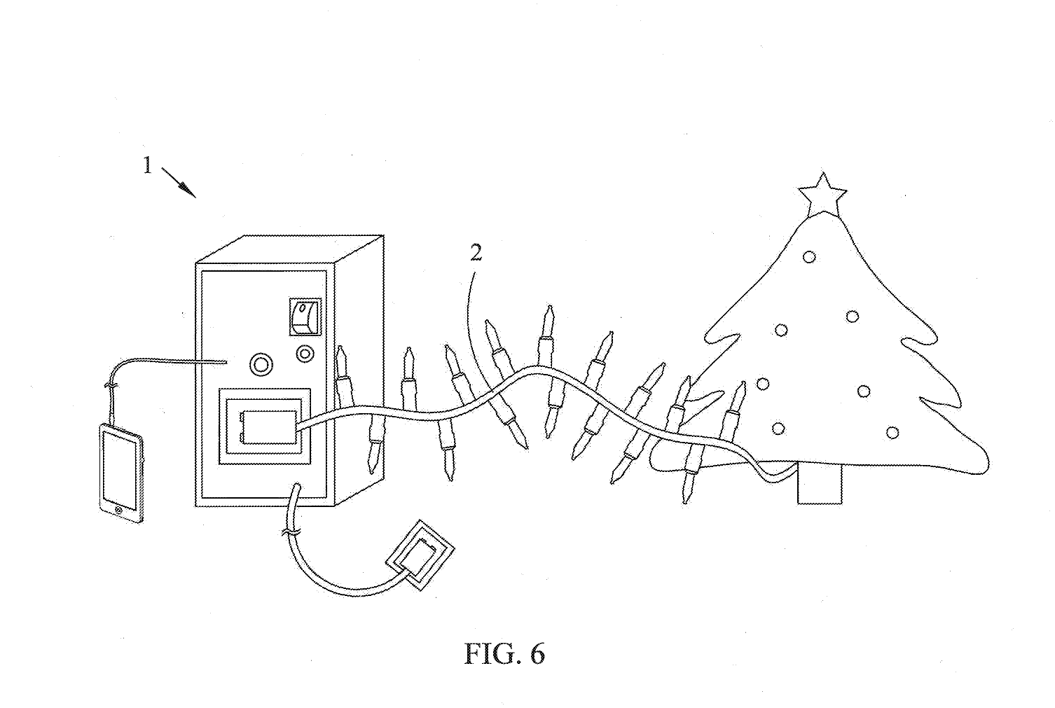

FIG. 5 illustrates a schematic diagram of a device that equips the audio controlled power supplying system according to the present invention and FIG. 6 illustrates a schematic diagram of one of the applications of the audio controlled power supplying system according to the present invention. Referring to FIGS. 5 and 6, one of the preferred embodiments of the application of the audio controlled power supplying system is shown. In FIG. 5, the light show speaker may have an audio output unit 11 at the front side thereof in order to output the audio signal. The power switch 17, regulator switch 14, reset unit 16 and the power output unit 18 may be disposed at the rear side. While in use, please refers to FIG. 6, the illuminating unit 2, such as a LED string, may connect to the audio controlled power supplying system 1 via the power output unit 18. As the result, the audio controlled power supplying system 1 may output the regulated power signal to the illuminating unit 2, and the illuminating unit 2 would be driven by the power source and illuminating the light according to the regulated power signal which would be corresponding to the tempo, the quantity of sound of the audio signal. It is worthy to note that the audio signal may be provided from any kind of device, such as PC, handheld electronic device or via wireless connection transmission.

According to at least one of the above-described embodiments, it is possible to provide a power control apparatus and power control method for selecting internal power supply according to a condition in actual requirement, and executing power signal providing according to the condition.

The various units of the embodiments described herein can be implemented as software applications, hardware and/or software modules, or components on one or more computers, such as remote servers. While the various units are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications so as would fall within the scope and spirit of the inventions.

What is claimed is:

1. An audio controlled power supplying system comprising:
an audio input unit receiving an audio signal from an audio source;
a processor electrically coupled to the audio input unit, the processor receiving the audio signal and analyzing the audio signal to generate a control signal; and
a power regulator electrically coupled to the processor, the power regulator receiving the control signal from the processor and regulating an input power signal of a power source according to the control signal to generate an output power signal.

2. The audio controlled power supplying system as set forth in claim 1, further comprising a regulator switch electrically coupled between the processor and the power regulator, the regulator switch enabling or disabling the control signal according to a switch status thereof;
wherein while the switch status is on, the control signal is transmitted to the power regulator, and while the switch status is off, the control signal is not transmitted to the power regulator.

3. The audio controlled power supplying system as set forth in claim 2, further comprising a surge protector electrically coupled between the power regulator and the power source, the surge protector interrupting transmission of the input power signal when current of the input power signal exceeds an overloading value.

4. The audio controlled power supplying system as set forth in claim 3, further comprising reset unit disposed in the surge protector, the reset unit resetting the surge protector to allow transmission of the input power Signal.

5. The audio controlled power supplying system as set forth in claim 1, wherein the power regulator regulates frequency or voltage of the input power signal according to the control signal.

6. The audio controlled power supplying system as set forth in claim 1, wherein the power regulator is selected from the group consisting of an RC circuit, a capacitor circuit, a transistor switch circuit and a diode switch circuit.

7. The audio controlled power supplying system as set forth in claim 1, further comprising an illuminating unit electrically coupled to the power regulator and the illuminating unit being illuminated according to the output power signal from the power regulator.

8. The audio controlled power supplying system as set forth in claim 7, wherein the illuminating unit comprises light emitting diode, incandescent light bulb, fluorescent lamp, sodium vapor lamp or high intensity discharge lamp.

9. The audio controlled power supplying system as set forth in claim 7, wherein the control signal is a pulse width modulation signal, and the brightness of the illuminating unit varies according to the pulse width modulation signal.

10. The audio controlled power supplying system as set forth in claim 1, wherein the control signal is generated according to amplitude analysis, frequency analysis or spectrum analysis of the audio signal.

11. The audio controlled power supplying system as set forth in claim 1, further comprising an audio output unit electrically coupled to the audio input unit, the audio output unit outputting the audio signal.

12. The audio controlled power supplying system as set forth in claim 1, further comprising an external speaker electrically coupled to the audio input unit.
